(19) United States
(12) Patent Application Publication
(10) Pub. No.: US 2007/0289219 A1
(43) Pub. Date: Dec. 20, 2007

(54) Sash Lift Mechanism

(75) Inventors: George E. Heid, Rockford, IL (US); O. Wayne Johnson, Rockford, IL (US); Julie Kathleen Earp, Rockford, IL (US); Gary M. Erickson, Lena, IL (US)

Correspondence Address: BANNER & WITCOFF, LTD., TEN SOUTH WACKER DRIVE, SUITE 3000, CHICAGO, IL, 60606, US

(73) Assignee: NEWELL OPERATING COMPANY, Atlanta, GA (US)

(21) Appl. No.: 11/763,015

(22) Filed: Jun. 14, 2007

Related U.S. Application Data
(60) Provisional application No. 60/814,019, filed on Jun. 14, 2006.

(51) Int. Cl. E05C 9/00

(52) U.S. Cl. 49/395

(57) ABSTRACT

A casement window assembly includes a hinged sash window pivotally mounted within a window frame. The casement window assembly has a sash lift mechanism having a base and a moveable member. The base is mounted on the window frame. The moveable member is pivotally supported by the base. In instances where the sash window may become misaligned within the window frame, the moveable member engages the sash window as the sash window moves to its closed position. The moveable member provides a lift force to the sash window to enhance the alignment of the sash window as the sash window is placed in the closed position.

### CROSS-REFERENCE TO RELATED APPLICATIONS

The present application is a continuation-in-part application of and claims the benefit of U.S. Provisional Patent Application No. 60/814,019, which application is incorporated by reference herein and made a part hereof.

### FEDERALLY SPONSORED RESEARCH OR DEVELOPMENT

None.

### TECHNICAL FIELD

The invention relates to casement windows, and more specifically, to a sash lift mechanism for a casement window assembly.

### BACKGROUND OF THE INVENTION

Casement window assemblies are known in the art and typically have a sash window pivotally mounted in a window frame by hinge assemblies. While casement window assemblies of the prior art provide a number of advantageous features, they nevertheless have certain limitations. For example, over time, the mounting structures for the sash window within the window frame can shift causing the sash window to sag or become slightly misaligned with the window frame causing less than optimal operation of the casement window assembly.

The present invention is provided to solve problems associated with casement window assemblies, and to provide advantages and aspects not provided by prior casement window assemblies. A full discussion of the features and advantages of the present invention is deferred to the following detailed description, which proceeds with reference to the accompanying drawings.

### SUMMARY OF THE INVENTION

The present invention provides a casement window assembly having a sash lift mechanism. The casement window assembly has a sash window pivotally supported in a window frame between open positions and a closed position.

According to one aspect of the invention, the sash lift mechanism includes a base and a moveable member pivotally attached to the base. The base is mounted to the window frame in one preferred embodiment. The moveable member is in the form of a finger that engages a sagging sash window and provides a lift force to the sash window as the sash window is being moved to the closed position. Once engaged by the sash window, the finger pivots to substantially a vertical configuration and provides lift to the sash window.

According to another aspect of the invention, the sash lift mechanism has a base adapted to be mounted on one of the window and the window frame. A moveable member is pivotably supported by the base. The moveable member is moveable by pivoting between a first position, wherein the moveable member is adapted to not engage the other of the window and the window frame, and a second position, wherein the moveable member is adapted to engage a surface of the other of the window and the window frame to provide a lift force to the window when the window is closed.

According to a further aspect of the invention, the moveable member is not visible when the window is closed.

According to another aspect of the invention, a top surface of the moveable member is adapted to engage a bottom surface of the window when the moveable member is in the second position. The moveable member is adapted to pivot from the first position to the second position in response to a pivoting force exerted upon the moveable member by the other of the window and the window frame as the window is closed.

According to another aspect of the invention, the moveable member has a finger having a nose and a top surface. The nose is adapted to engage the other of the window and the window frame such that the pivoting force is exerted upon the nose, and the top surface is adapted to engage the surface of the other of the window and the window frame to provide the lift force to the window.

According to yet another aspect of the invention, the moveable member has a first finger and a second finger, wherein the first finger is adapted to engage the other of the window and the window frame such that the pivoting force is exerted upon the nose, and the second finger is adapted to engage the surface of the other of the window and the window frame to provide the lift force to the window.

According to another aspect of the invention, the base has a slot therein and a portion of the moveable member is pivotably received in the slot. In one exemplary embodiment, the base is adapted to be mounted on the window frame and the moveable member is adapted to engage a surface of the window in the second position.

According to a further aspect of the invention, the moveable member is adapted to engage a surface of the other of the window and the window frame to provide a lift force to the window only when the window is sagging from alignment with the window frame.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a casement window assembly utilized with the present invention;

FIG. 2 is a partial cross-sectional view of a casement window assembly of the present invention;

FIG. 3 is an end view of the casement window assembly of FIG. 2 showing a sash lift mechanism in a forward position;

FIG. 4 is an enlarged end view of the casement window assembly shown in FIG. 3;

FIG. 5 is an enlarged perspective view of the casement window assembly shown in FIG. 4;

FIG. 6 is an end view of the casement window assembly of FIG. 2 showing the sash lift mechanism in a free position;

FIG. 7 is an enlarged end view of the casement window assembly shown in FIG. 6;

FIG. 8 is an end view of the casement window assembly of FIG. 2 showing the sash lift mechanism in an upright position;

FIG. 9 is an enlarged end view of the casement window assembly shown in FIG. 8;

FIG. 10 is an enlarged perspective view of the casement window assembly shown in FIG. 9;

FIG. 11 is a rear perspective view of a casement window assembly according to another embodiment of the present invention;

FIG. 12 is a front perspective view of the casement window assembly shown in FIG. 11;

FIG. 13 is a front perspective view of the casement window assembly shown in FIG. 12, the casement window assembly being in an open position;

FIG. 14 is a rear elevation view of the casement window assembly shown in FIG. 11, the casement window assembly being in an open position;

FIG. 15 is a rear exploded perspective view of the casement window assembly shown in FIG. 11, the casement window assembly being in an open position and showing a sash lift mechanism;

FIG. 16 is a perspective view of the sash lift mechanism shown in FIG. 15;

FIG. 17 is a perspective view of a base of the sash lift mechanism shown in FIG. 16;

FIG. 18 is a perspective view of a moveable member of the sash lift mechanism shown in FIG. 16;

FIG. 19 is a side view of the moveable member shown in FIG. 18;

FIG. 20 is a rear perspective view of the moveable member shown in FIG. 18;

FIG. 21 is a side view of the sash lift mechanism shown in FIG. 16;

FIG. 22 is a front elevation view of the sash lift mechanism shown in FIG. 16;

FIG. 23 is a rear elevation view of the sash lift mechanism shown in FIG. 16;

FIG. 24 is a top view of the sash lift mechanism shown in FIG. 16;

FIG. 25 is a bottom view of the sash lift mechanism shown in FIG. 16;

FIG. 26 is a schematic side view of the sash lift mechanism mounted on the casement window assembly; and

FIG. 27 is a schematic side view of the sash lift mechanism shown in FIG. 26 wherein the moveable member is pivoted by a sash window of the casement window assembly and providing an upward force to the sash window.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

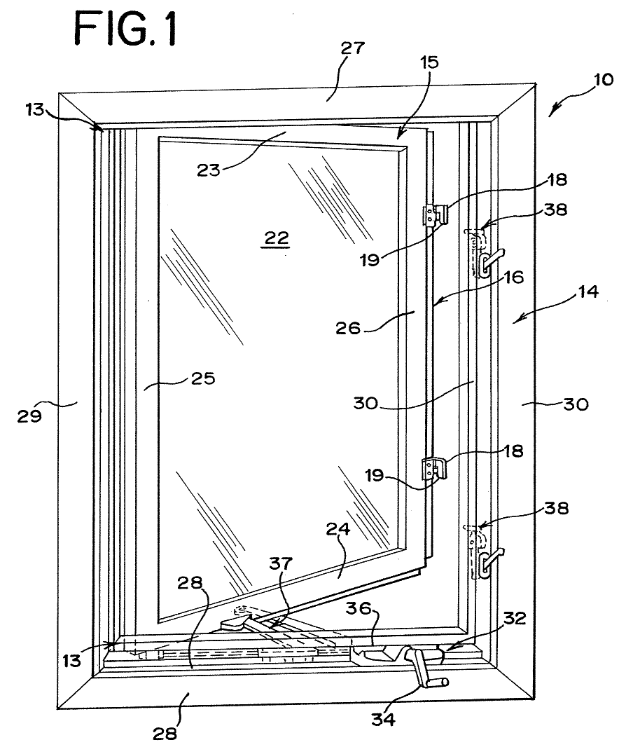

FIG. 1 shows a casement window assembly 10, which includes a jamb frame assembly or window frame 14, and an inner window assembly 16 or sash window 16. The inner window assembly 16 is formed of a sash window frame 15 bordering a window pane 22. The sash window frame 15 is formed by two vertical rails 25,26 and two horizontal rails 23,24. The window frame 14 is formed by two vertical jambs 29,30 and two horizontal jambs 27,28. The sash window 16 and window 14 are secured by hinged connections 13, such that the sash window 16 is moveable between an open and closed position relative the window frame 14 by pivotal movement of the sash window 16. FIG. 1 depicts the window assembly 10 with the inner window assembly 16 pivoted into the open configuration relative the frame 14. The inner window assembly 16 is moved by an operator assembly 32 that includes an actuator 34, a housing 36 mounted on the bottom jamb 28, and one or more movable operating arms 37 that move back and forth by cranking the actuator 34 to move the inner window assembly 16. The hinged connection 13 includes a hinge assembly that pivotably supports the window assembly 16. Two locking mechanisms 38 are positioned on one of the vertical jambs 30 and the adjacent vertical rail 26 to secure the jamb 30 to the rail 26, locking the window assembly 10 shut. Two keepers 18, each having an extending finger 19, are positioned on the vertical rail 26 adjacent the locking mechanisms 38 for this purpose.

Accordingly, it is understood that a user can use the operator assembly 32 to open and close the casement window assembly 10 as desired. Over time, it is not uncommon for the sash window 16 to slightly shift with respect to the window frame 14. This is due to various factors including the weight of the sash window, the hinged connections and other forces that may be applied to the casement window assembly 10 over time. This may cause the sash window 16 to become misaligned with respect to the window frame 14. This can affect proper closure of the casement window assembly 10 wherein a user may experience difficulties in properly placing the sash window 16 in a closed position with respect to the window frame 14. This can also place undue stress on the components of the operator 32. A sash lift mechanism 50 of the present invention assists in correcting any misalignment problems.

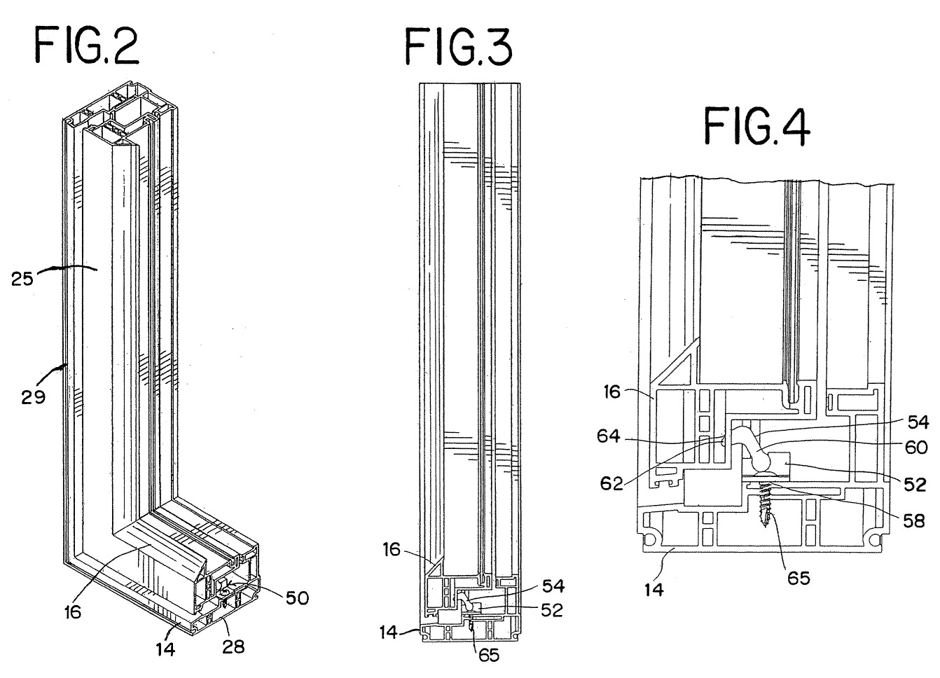

FIGS. 2-5 show the sash lift mechanism 50 utilized in a casement window assembly having similar components as described with respect to FIG. 1. It is understood that the sash lift mechanism 50 can be utilized in other types of window assemblies as well as other structures needing a lift force. As shown in FIGS. 2-5, the sash lift mechanism 50 generally includes a base 52 and a moveable member 54. In one preferred embodiment, the moveable member may take the form of a finger 54. In another exemplary embodiment, the moveable member 54 may be pivotally supported by the window frame. It is further understood that in the exemplary embodiments disclosed in the present application, the moveable member 54 may be mounted on one of the window frame and the sash window as desired by a manufacturer or user.

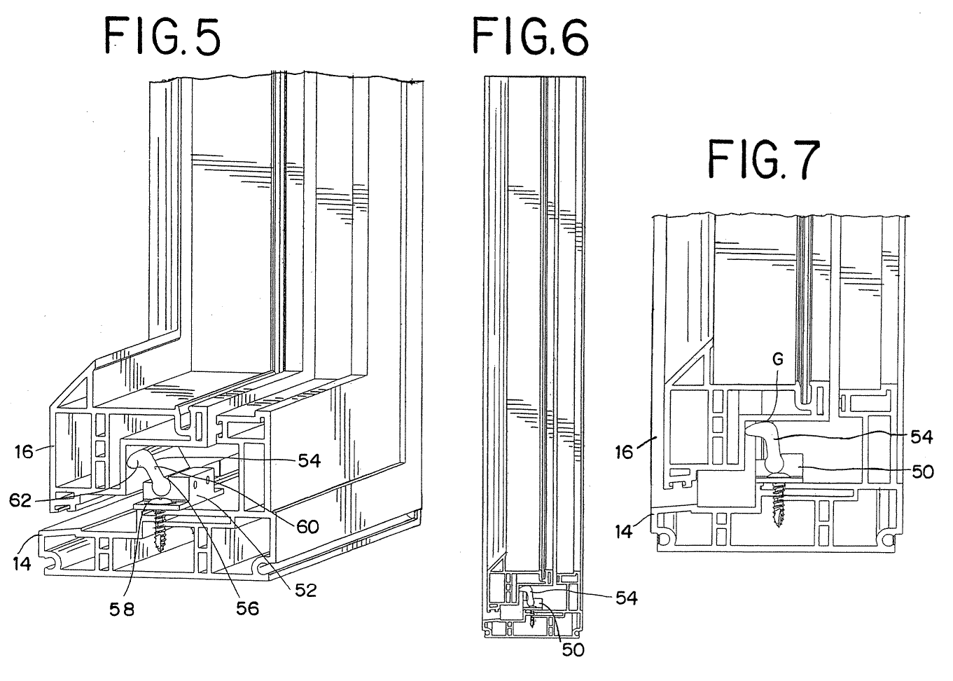

As shown in greater detail in FIGS. 4 and 5, the base 52 has a generally box-like configuration and has a central opening 56 or slot 56. The central opening 56 has a generally rounded configuration and receives the finger 54. The base 52 also has a fastener opening 58. In a preferred embodiment, the base 52 has a pair of fastener openings 58 (one fastener opening 58 not shown). A front portion of the base 52 has a height slightly less than a rear portion of the base 52. As further shown in FIGS. 4 and 5, the finger 54 has a first segment 60 and a second segment 62 in the form of a nose 62 or tab 62 that extends generally transverse to the first segment 60. A first end of the first segment 60 has a generally rounded configuration that generally corresponds to the rounded configuration of the central opening 56. The first segment 60 is received by the central opening 56 and is pivotally supported by the base 52 to be described in greater detail below. The finger 54 thus generally extends away from the base 52. As further shown in FIGS. 4 and 5, the base 52 is mounted on the window frame 14 by screws 65 that pass through the fastener holes.

The finger 54 moves among different positions. FIGS. 4 and 5 show the finger 54 in a forward position wherein the finger does not engage the sash window 16. In this instance, the sash window 16 has a proper alignment with the window frame 14. In this configuration, the sash lift mechanism 50 may be considered to be in an inactive state or free position. An opening 64 may be provided in a frame member of the sash window 16 wherein the second segment 62 of the finger 54 passes through the opening 64. FIGS. 6 and 7 show the finger 54 in the free position. In this position, the sash window 16 still has proper alignment with the window frame 14. The finger 54 can be pivot to more of a vertical position. Because there is still proper sash window alignment, however, the sash window 16 does not engage the finger 54. A small gap G is maintained between the finger 54 and the sash window 16. Thus, the sash lift mechanism 50 is in the inactive state.

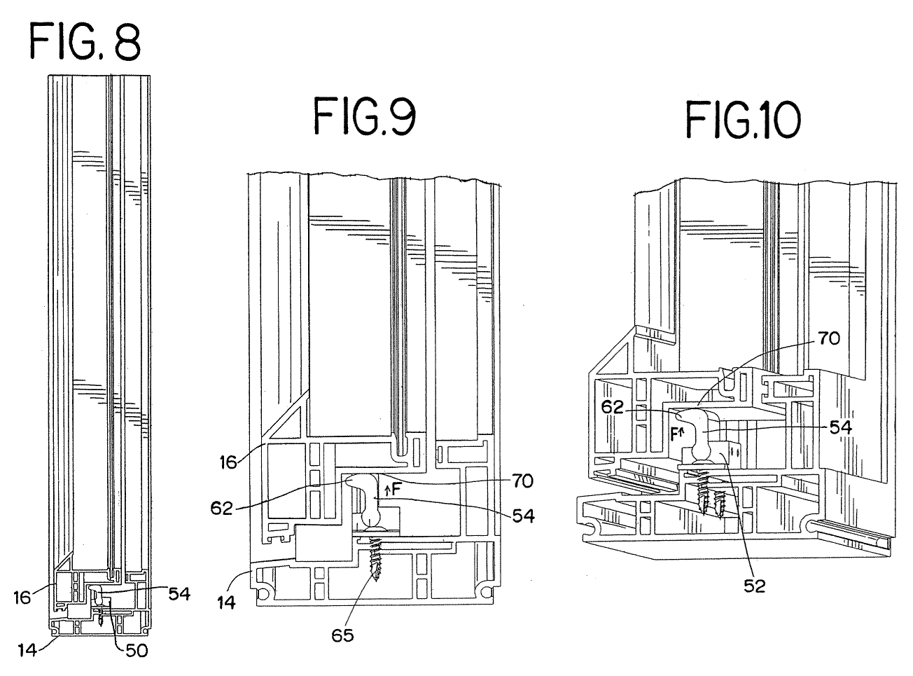

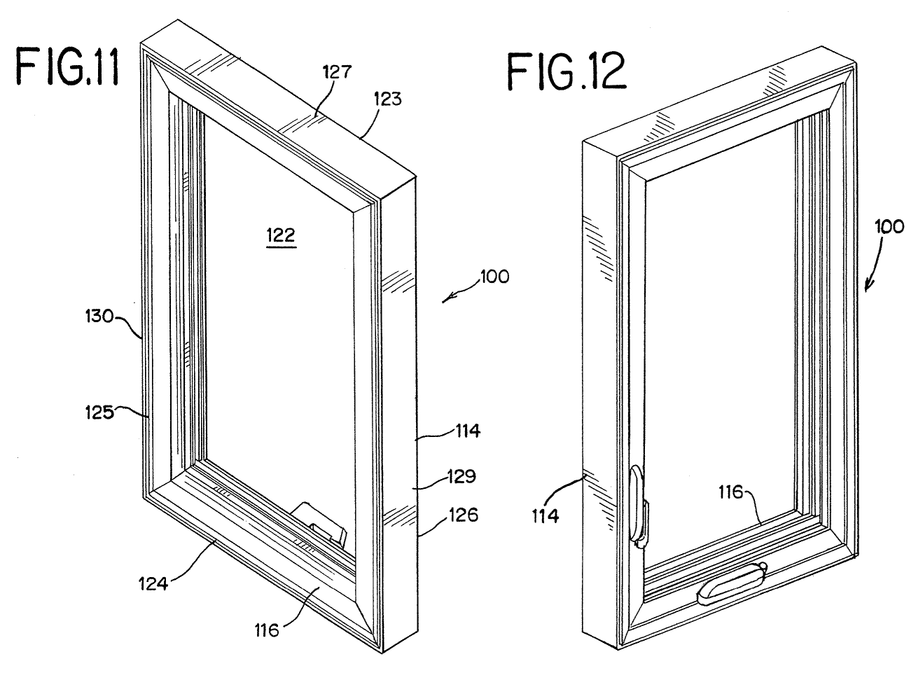

FIGS. 8-10 show the finger 54 in an upright position and providing a lift force to the sash window 16. As discussed, over time, the sash window 16 may become misaligned with the window frame 14 wherein the sash window 16 sags with respect to the window frame 14. In such instance, the sash window 16 will not be able to close properly. As shown in FIGS. 8-10 and as can be appreciated from FIGS. 4 and 5, the finger 54 will be in the forward position. As the sagging sash window 16 is moved to the closed position, a portion 70 of the sash window 16, engages the second segment 62 of the finger 54 wherein the finger 54 pivots within the base 52 to a generally vertical position. The finger 54 is dimensioned such that as the finger 54 continues to pivot by the sash window 16 moving to the closed position, the finger 54 provides a lift force F to the sash window 16. Specifically, a top surface of the second segment 62 of the finger 54 engages an underside or bottom surface of the portion 70 of the sash window 16 to lift the sash window 16. With this force F, the sagging of the sash window 16 is eliminated and the sash window 16 is properly aligned wherein the sash window 16 can be easily placed in the closed position. After the sash window 16 is placed in an open position and then closed again, the sash lift mechanism 50 will again operate as just described to provide an upward lift force F to the sagging sash window 16.

It is understood that the sash lift mechanism 50 can take other forms or be placed in other locations on the casement window assembly 10. The sash lift mechanism is structured and positioned to provide lift to a sash window 16 that has sagged with respect to the window frame 14. Thus, even if the sash window 14 has sagged and a user cannot properly realign the sash window 16 utilizing other standard methods known in the industry, the finger 54 can provide the appropriate lift force F that can enhance the alignment of the sash window 16. Accordingly, the overall operation of the casement window assembly 10 is enhanced.

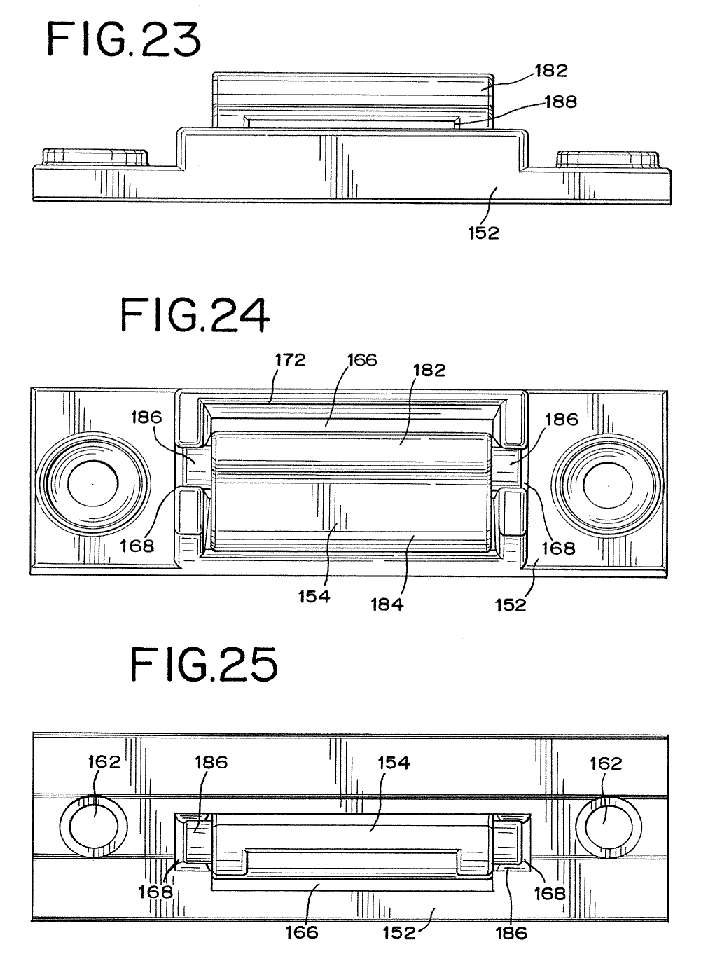

FIGS. 11-27 disclose another exemplary embodiment of the present invention utilizing a sash lift mechanism with a casement window assembly. Similar structures from the embodiment of FIGS. 1-10 will be designated with similar reference numerals using a 100 series designation.

FIGS. 11-15 show another casement window assembly 100 which includes a jamb frame assembly or window frame 114, and an inner window assembly 116 or sash window 116. The casement window assembly 100 of FIGS. 11-15 is similar to the casement window assembly 10 in FIG. 1. As further shown in FIG. 13, the inner window assembly 116 is formed of a sash window frame 115 bordering a window pane 122. The sash window frame 115 is formed by two vertical rails 125,126 and two horizontal rails 123,124. The window frame 114 is formed by two vertical jambs 129,130 and two horizontal jambs 127,128. The sash window 116 and window 114 are secured by hinged connections 113, such that the sash window 116 is moveable between an open and closed position relative the window frame 114 by pivotal movement of the sash window 16. FIG. 11 shows a rear view of the window assembly 100 such as outside of a residence or building and in a closed position. FIG. 12 shows a front view of the casement window assembly 100 such as from inside of a residence or building and in a closed position. FIGS. 13-15 show front and rear views of the casement window assembly 100 in an open position wherein the inner window assembly 116 is pivoted into the open configuration relative the frame 114. The inner window assembly 116 is moved by an operator assembly 132 that includes an actuator 134, a housing 136 mounted on the bottom jamb 128, and one or more movable operating arms 137 that move back and forth by cranking the actuator 134 to move the inner window assembly 116. The hinged connection 113 includes a hinge assembly that pivotably supports the window assembly 116. A locking mechanism 138 is positioned on one of the vertical jambs 129 and the adjacent vertical rail 126 to secure the jamb 130 to the rail 126, locking the window assembly 100 shut. Two keepers 118 are positioned on the vertical rail 126 for this purpose.

As discussed above, a user can use the operator assembly 132 to open and close the casement window assembly 100 as desired. Over time, the sash window 116 may slightly shift with respect to the window frame 114. This is due to various factors including the weight of the sash window 116, the hinged connections and other forces that may be applied to the casement window assembly 100 over time. This may cause the sash window 116 to become misaligned with respect to the window frame 114. This can affect proper closure of the casement window assembly 100 wherein a user may experience difficulties in properly placing the sash window 116 in a closed position with respect to the window frame 114. A sash lift mechanism 150 of the present invention assists in correcting any misalignment problems.

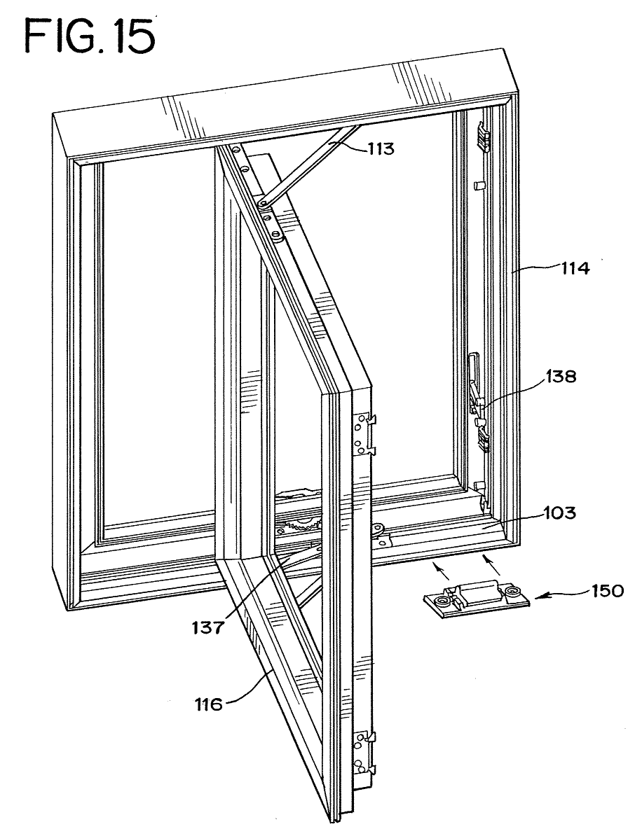

As shown in FIGS. 15-16, the sash lift mechanism 150 generally includes a base 152 and a moveable member 154. In one exemplary embodiment, the moveable member may take the form of a finger or a plurality of fingers. As explained in greater below, the moveable member 154 is pivotally supported by the base 152. It is understood, however, that the moveable member 154 could be supported by the window frame 114 or the sash window 116.

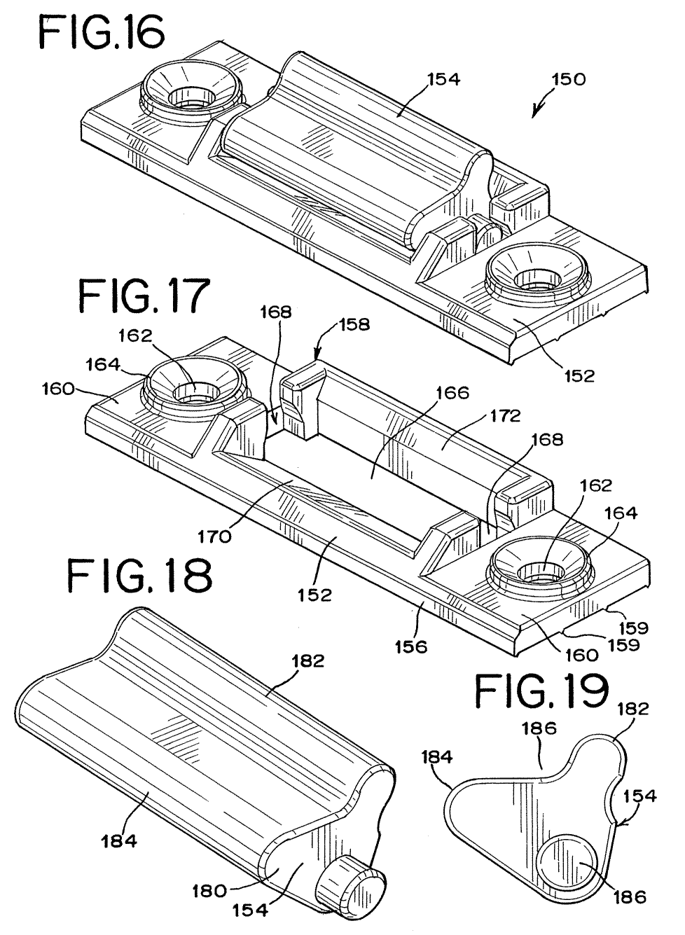

FIG. 17 further shows the base 152. The base 152 has a body 156 having a central wall portion 158 and a pair of flanges 160, one flange 160 on opposite sides of the wall portion 158. Each flange 160 has a mounting opening 162 to receive a fastener (e.g., fastener 65 in FIG. 3) as described in greater detail below. The flange 160 may include a raised rim 164 around the opening 162. The central wall portion 158 defines a central opening 166 or slot 166. The slot 166 is generally dimensioned to receive the moveable member 154 as described in greater detail below. The central wall portion 158 is open at two top locations to define a pair of channels 168 that are in communication with the slot 166. The channels 168 may taper inwards at an upper portion. One channel 168 is located on each side of the slot 166. The wall portion 158 further defines a front engagement surface 170 and a rear engagement surface 172. A bottom portion of the base 152 may also have ribs 159 that may assist in its mounting to the window frame 116.

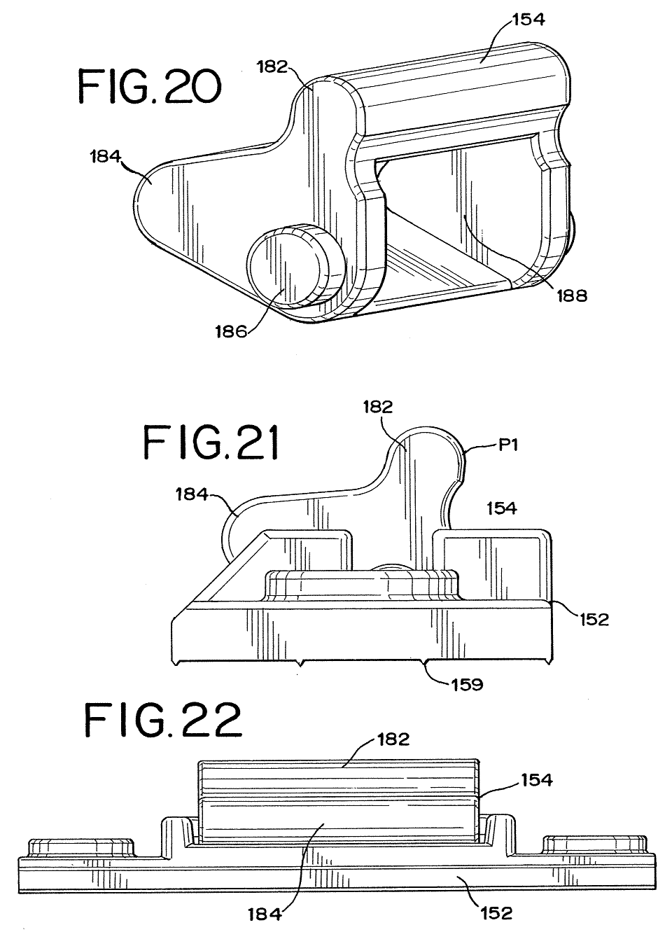

FIGS. 18-20 show the moveable member 154. In one exemplary embodiment, the moveable member 154 may have one or more fingers. The moveable member 154 has a body 180 that has an elongated dimension to generally fit the slot 166. The body 180 has a first finger 182 and a second finger 184. The first finger 182 and the second finger 184 extend from the body 180 and define a recess 186 between the fingers 182,184. The body 180 and fingers 182,184 have generally contoured surfaces. As further shown in FIGS. 18-20, a peg 186 extends from each side of the body 180. Finally, as shown in FIG. 20, a rear side of the body 180 has a hollowed-out portion 188.

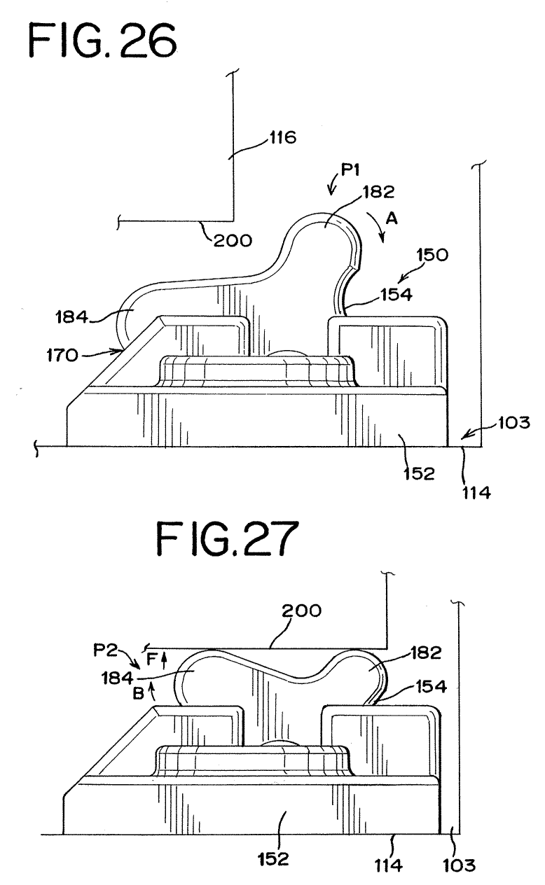

As further shown in FIGS. 16 and 21-25, the base 152 moveably supports the moveable member 154. In particular, the moveable member 154 is received in the slot 166. A portion of the body 180 fits within the slot 166 and the fingers 182,184 extend from the walled portion of the base 154. The pegs 186 are also received in the channels 168 wherein the channels 168 cradle the pegs 186 wherein the pegs 186 can rotate within the channels 168. In this configuration, the moveable member 154 is pivotally supported in the base 154 between a first position P1 (FIGS. 21 and 26) and a second position P2 (FIG. 27) as described in greater detail below. It is understood that a certain level of interference such as from the tapered portions may be provided between the channels 168 and pegs 186 to maintain the moveable member 154 within the base 152 while still allowing pivoting of the moveable member 154.

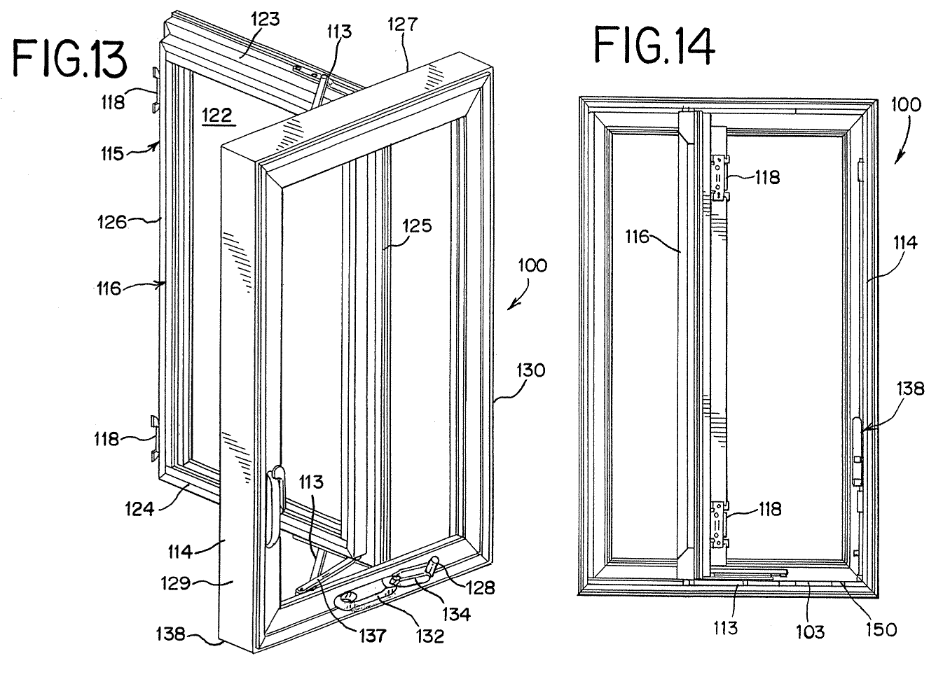

As shown in FIGS. 14 and 15, the sash lift mechanism 150 is mounted on the window frame 114. In particular the sash lift mechanism 150 is positioned on a hinge groove 103 of the bottom jamb 128 of the window frame 114. Fasteners such as shown in FIG. 3, are inserted through the mounting openings 162 and into the window frame 114 at the hinge groove 103. When the window is closed, the sash lift mechanism 150 including the moveable member 154 is not visible (See e.g., FIG. 11). On the window frame 114, the moveable member 154 can pivot between the first position P1 and the second position P2. As previously discussed, when the sash window 114 is not in a sagging condition, the sash window 114 can move between its open and closed positions and not engage the sash lift mechanism 150, wherein the sash lift mechanism 150 is considered to be in an inactive state and the sash window 114 is in a free or normal state.

Once the sash window 116 reaches a sagging condition, whether initially or over time, the sash window 116 will engage the sash lift mechanism 150 as can be appreciated from FIGS. 26 and 27. FIG. 26 shows the sash lift mechanism 150 in its first position P1 wherein the first finger 182 extends generally upwards and wherein the second finger 184 rests against the front engagement surface 170. Because of the sagging condition, as the sash window 116 is moved to the closed position, the vertical position of the sash window 116 is such that it engages the first finger 182 as can be appreciated from FIG. 26. As the sash window 116 continues to close, the moveable member 154 pivots within the base 152 from the engagement with the sash window 116 (See e.g., arrow A in FIG. 26). Referring to FIG. 27, as the moveable member 154 pivots, the second finger 184 pivots upwards as shown by arrow B and engages an underside surface or bottom surface 200 of the sash window 116. As the sash window 116 continues to close, the second finger 184 continues to engage the sash window 116 wherein both the first finger 182 and the second finger 184 engage the underside surface 200. Because of the structure of the second finger 184, the second finger 184 provides an upward lift force F to the sash window 116 to eliminate the sagging problem of the sash window 116. In this configuration, the sash lift mechanism 150 is considered to be in the active state, wherein a lift force F is provided by the moveable member 154 upon the sagging sash window 116.

Similar to the previous exemplary embodiment shown in FIGS. 1-10, the sash lift mechanism 150 can take other forms or be placed in other locations on the casement window assembly 100. It is further understood that the sash lift mechanism 150 could be mounted on the sash window 116. In the exemplary embodiments illustrated, however, the sash lift mechanism 150 is mounted on the window frame 114. It is also understood that the moveable member 154 could be structured to be pivotally mounted to the window frame 114 or sash window 116 or that the window frame 114 or sash window 116 could be considered a base member 152. It is further understood that a plurality of sash lift mechanisms 150 can be utilized if desired. In addition, the moveable member 154 could also include additional fingers that cooperate in successive movements to provide additional lift forces to further raise a sagging window, such as larger size sash windows 116. In the active state, the sash lift mechanism 150 is structured and positioned to provide lift to a sash window 116 that has sagged with respect to the window frame 114. Thus, even if the sash window 114 has sagged and a user cannot properly realign the sash window 116 utilizing other standard methods known in the industry, the sash lift mechanism 150 can provide the appropriate lift force F that can enhance the alignment of the sash window 116. Accordingly, the overall operation of the casement window assembly 100 is enhanced. Finally, it is understood that the different sash lift mechanisms 50,150 can be used in the different casement window assemblies disclosed. Furthermore, the sash lift mechanism 50,150 can also be utilized in other types of window assemblies, door assemblies or other applications utilizing a member pivotally supported by a frame requiring a force to enhance operation due to alignment issues. In certain instances, the force provided may be in other directions rather than only an upward lift force depending on the configuration of the structures utilized.

While the specific embodiments have been illustrated and described, numerous modifications come to mind without significantly departing from the spirit of the invention, and the scope of protection is only limited by the scope of the accompanying Claims.

What is claimed is:

1. A sash lift mechanism for a casement window assembly having a hinged window pivotably mounted within a window frame, the sash lift mechanism comprising:
a base adapted to be mounted on one of the window and the window frame; and
a moveable member pivotably supported by the base, the moveable member being moveable by pivoting between a first position, wherein the moveable member is adapted to not engage the other of the window and the window frame, and a second position, wherein the moveable member is adapted to engage a surface of the other of the window and the window frame to provide a lift force to the window when the window is closed.

2. The sash lift mechanism of claim 1, wherein the moveable member is not visible when the window is closed.

3. The sash lift mechanism of claim 1, wherein a top surface of the moveable member is adapted to engage a bottom surface of the window when the moveable member is in the second position.

4. The sash lift mechanism of claim 1, wherein the moveable member is adapted to pivot from the first position to the second position in response to a pivoting force exerted upon the moveable member by the other of the window and the window frame as the window is closed.

5. The sash lift mechanism of claim 4, wherein the moveable member has a finger having a nose and a top surface, wherein the nose is adapted to engage the other of the window and the window frame such that the pivoting force is exerted upon the nose, and the top surface is adapted to engage the surface of the other of the window and the window frame to provide the lift force to the window.

6. The sash lift mechanism of claim 4, wherein the moveable member has a first finger and a second finger, wherein the first finger is adapted to engage the other of the window and the window frame such that the pivoting force is exerted upon the nose, and the second finger is adapted to engage the surface of the other of the window and the window frame to provide the lift force to the window.

7. The sash lift mechanism of claim 1, wherein the base has a slot therein and a portion of the moveable member is pivotably received in the slot.

8. The sash lift mechanism of claim 1, wherein the base is adapted to be mounted on the window frame and the moveable member is adapted to engage a surface of the window in the second position.

9. The sash lift mechanism of claim 1, wherein the moveable member is adapted to engage a surface of the other of the window and the window frame to provide a lift force to the window only when the window is sagging from alignment with the window frame.

10. A sash lift mechanism for a casement window assembly having a hinged window pivotably mounted within a window frame, the sash lift mechanism comprising:
a base adapted to be mounted on the window, the base having a slot therein; and
a moveable member comprising a body having a portion pivotably received in the slot of the base, a first finger extending from the body, and a second finger extending from the body, the moveable member being moveable by pivoting between a first position and a second position,
wherein when the window is moved to a closed position, the first finger of the moveable member is adapted to engage the window such that the window exerts a pivoting force on the first finger to pivot the moveable member from the first position to the second position, and
wherein when the moveable member pivots from the first position to the second position, the second finger is adapted to engage the window to provide a lift force to the window as the window is moved to the closed position.

11. A casement window assembly comprising:
a window frame;
a hinged window pivotably supported within the window frame in one of a normal condition and a sagging condition, the window moveable between an open position and a closed position; and
a sash lift mechanism comprising:
a base mounted on one of the window and the window frame; and
a moveable member supported by the base, the moveable member being in an inactive state when the window is in the normal condition, wherein the moveable member does not engage the other of the window and the window frame when the window is moved to the closed position, the moveable member being in an active state when the window is in the sagging condition, wherein the moveable member engages the other of the window and the window frame and provides a lift force on the window when the window is moved to the closed position.

12. The casement window assembly of claim 11, wherein when the window is in the open position, the moveable member in the inactive state is in a position and the moveable member in the active state is in the same position.

13. The casement window assembly of claim 11, wherein when the window is in the normal condition, the other of the window and the window frame is spaced from the moveable member when the window is in the closed position, and when the window is in the sagging condition, the sagging of the window causes the other of the window and the window frame to engage the moveable member.

14. The casement window assembly of claim 11, wherein the moveable member is adapted to pivot from a first position to a second position in response to a pivoting force exerted upon the moveable member by the other of the window and the window frame as the window is moved to the closed position, and wherein the moveable member exerts the lifting force on the window as the moveable member pivots to the second position.

15. The sash lift mechanism of claim 14, wherein the moveable member has a finger having a nose and a top surface, wherein the nose is adapted to engage the other of the window and the window frame such that the pivoting force is exerted upon the nose, and the top surface is adapted to engage the other of the window and the window frame to provide the lift force to the window.

16. The sash lift mechanism of claim 14, wherein the moveable member has a first finger and a second finger, wherein the first finger is adapted to engage the other of the window and the window frame such that the pivoting force is exerted upon the nose, and the second finger is adapted to engage the other of the window and the window frame to provide the lift force to the window.

17. The casement window assembly of claim 11, wherein the base is mounted on the window frame and the moveable member engages a surface of the window to provide the lift force on the window in the active state.

18. The casement window assembly of claim 17, wherein the window frame includes a bottom jamb comprising a hinge groove and an upper surface stepped above the hinge groove, and wherein the base is mounted to the hinge groove of the bottom jamb.

19. The casement window assembly of claim 11, wherein the moveable member is not visible from outside the window assembly when the window is in the closed position.

20. The casement window assembly of claim 11, wherein the base has a slot therein and a portion of the moveable member is pivotably received in the slot.

21. A sash lift mechanism for a casement window assembly having a hinged window pivotably mounted within a window frame, the sash lift mechanism comprising:
a moveable member adapted to be pivotally coupled to the window frame, the moveable member being moveable by pivoting between a first position, wherein the moveable member is adapted to not engage the window frame, and a second position, wherein the moveable member is adapted to engage a surface of the window to provide a lift force to the window when the window is closed.

22. The sash lift mechanism of claim 21 wherein the moveable member has a finger and nose extending from the finger, the nose adapted to engage the window such that a pivoting force is exerted upon the nose, and the nose is adapted to engage the window frame to provide the lift force to the window.

23. The sash lift mechanism of claim 21 wherein the moveable member has a first finger and a second finger, wherein the first finger is adapted to engage the window such that the pivoting force is exerted upon the nose, and the second finger is adapted to engage the window to provide the lift force to the window.

24. The sash lift mechanism of claim 21 further comprising a base adapted to be mounted on the window frame, the base having a slot therein and a portion of the moveable member is pivotably received in the slot.

25. A casement window assembly comprising:
a window frame;
a hinged window pivotably supported within the window frame in one of a normal condition and a sagging condition, the window moveable between an open position and a closed position; and
a sash lift mechanism comprising:
a base mounted on the window frame; and
a moveable member supported by the base, the moveable member being in an inactive state when the window is in the normal condition, wherein the moveable member does not engage the window when the window is moved to the closed position, the moveable member being in an active state when the window is in the sagging condition, wherein the moveable member engages the window and provides a lift force on the window when the window is moved to the closed position.

26. A sash lift mechanism for a casement window assembly having a hinged window pivotally mounted within a window frame, the sash lift mechanism comprising:
a moveable member adapted to be pivotally supported on the window frame, the moveable member adapted to engage the sash window as the sash window is moved to a closed position wherein the moveable member is adapted to provide a lift force to the sash window.
